(19) United States
(12) Patent Application Publication
(10) Pub. No.: US 2010/0250371 A1
(43) Pub. Date: Sep. 30, 2010

(54) ADVERTISEMENT CUSTOMIZATION SYSTEM AND METHOD

(75) Inventors: Ying-Tsung Lee, Taipei (TW); Ho-Chung Wang, Taipei (TW); Ying-Lung Li, Taipei (TW); Wei-Wei Tseng, Taipei (TW); Ling-Yueh Chang, Taipei (TW); Meng-Kai Tsai, Taipei (TW); Yu-Ling Chuang, Taipei (TW)

Correspondence Address: PEARNE & GORDON LLP, 1801 EAST 9TH STREET, SUITE 1200, CLEVELAND, OH, 44114-3108, US

(73) Assignee: CHUNGHWA TELECOM CO., LTD., Taipei (TW)

(21) Appl. No.: 12/554,965

(22) Filed: Sep. 7, 2009

(30) Foreign Application Priority Data
Mar. 27, 2009 (TW) 098110070

(51) Int. Cl. G06Q 30/00; G06F 17/30; G06F 17/40

(52) U.S. Cl. 705/14.67; 707/E17.044

(57) ABSTRACT

Provided are an advertisement customization system and method applied in a network system, characterized by an advertisement supply platform classifying advertisement data according to the properties thereof; the service supply platform selecting from the classified advertisement data advertisement data corresponding to the service supply platform; the service supply platform providing service data via the network system to the user end device; and the advertisement supply platform providing the corresponding advertisement data to the user end device when the user end device captures the service data provided by the service supply platform. The present invention enables the service supply platform to connect to the advertisement supply platform for customizing the advertisement data related to the service content, thereby increasing the view rate of the advertisement data and increasing advertisers' willingness to advertise.

### BACKGROUND OF THE INVENTION

1. Field of the Invention

The present invention relates to advertisement customization systems and methods, and more particularly to a system and method for providing customized advertisement data to a user end device when the user end device captures service data.

2. Description of Related Art

As the Internet penetration increases and network systems develop, information traditionally presented by television, newspapers or other media can be obtained through networks, and even transactions can be carried out through such networks. As such, these network systems are playing an increasingly important role in the overall consumer market. Therefore, in that advertising enhances product exposure, a large number of network advertisements are produced, perhaps exceeding conventional advertisements in number, quality and effect.

At present, advertising services are provided by portal websites such as Yahoo and PChome and also provided by personal web pages such as blogs and vlogs. Generally, the portal websites provide several advertising blocks on home pages thereof and users can visit advertising web pages by clicking the advertising blocks. Alternatively, the portal websites provide pop-up advertisements. Some search websites display search results along with advertisements related to input keywords.

Recent popular blogs provide users with a platform to express themselves and interact with visitors. Vlogs enhances the sprit of sharing or community. Since these personal web pages may be browsed by tens of thousands of people each day, advertisers prefer to place their advertisements on these personal web pages to attract viewers.

Taiwan Patent Publication No. 200809673 discloses a method of placing an advertisement in a blog, which comprises: selecting and duplicating an advertisement data file in an advertisement supply area after a blogger logs in to an advertisement marketing platform and passes verification; and attaching the advertisement data file to the blog.

However, the above technique has the following drawbacks:
(1) Customization of related advertisements cannot be achieved. In most cases, advertisements provided by advertisers are not related to the content of the host websites, and these advertisements cannot be replaced or modified. Meanwhile, the content of the advertisements is restricted to text or images, which may lack attraction for viewers.
(2) Viewers can easily skip advertisements and directly browse the content of web pages or websites if the content and advertisements are located in different regions. On the other hand, if pop-up advertisements are utilized, viewers may be annoyed by the pop-up advertisements or use software to block them.

Therefore, there is a need to provide an advertisement customization system and method to enable viewers to indirectly view advertisements without being annoyed, thereby increasing the advertising rate and the view rate of such advertisements.

### SUMMARY OF THE INVENTION

According to the above drawbacks, the present invention provides an advertisement customization system applied in a network system, which comprises: a user end device; a service supply platform connected to the user end device through the network system for supplying service data to the user end device and generating platform information corresponding to the service data; and an advertisement supply platform connected to the service supply platform through the network system for providing advertisement data to the user end device when the user end device captures the service data of the service supply platform, wherein the advertisement supply platform comprises: a database for storing the advertisement data; a management module for classifying the advertisement data in the database; and a correspondence module which transmits the advertisement data that corresponds to the platform information to the user end device when the user end device captures the service data of the service supply platform.

In a preferred embodiment, the advertisement customization system further comprises an advertisement data website for providing the advertisement data to the advertisement supply platform.

The present invention further provides an advertisement customization method applied in an advertisement customization system. The advertisement customization method comprises the steps of: (1) an advertisement supply platform classifying advertisement data stored in a database; (2) a service supply platform logging in to the advertisement supply platform for setting the classified advertisement data so as to form settings; (3) the service supply platform providing service data to a user end device through a network system; and (4), when the user end device captures the service data, the advertisement supply platform provides corresponding advertisement data through the network system to the user end device according to the settings.

In a preferred embodiment, step (2) further comprises: (2-1) the service supply platform inputting a username and password so as to log in to the advertisement supply platform; (2-2) the advertisement supply platform verifying the username and password; and (2-3), after passing verification, the service supply platform setting the classified advertisement data so as to form the settings.

According to the present invention, a management module disposed in an advertisement supply platform is used for managing and classifying advertisement data of the advertisement supply platform. Further, when a user end device captures service data of a service supply platform, the advertisement supply platform provides corresponding advertisement data to the user end device according to platform information provided by the service supply platform. In that the advertisement data provided to the user end device is related to the service data, user interest in browsing the advertisements and advertisers' willingness to advertise are increased.

### BRIEF DESCRIPTION OF DRAWINGS

FIG. 1 is a system block diagram showing an advertisement customization system according to the present invention;

FIG. 2 is a flow diagram showing an advertisement customization method according to the present invention;

FIG. 3 is a flow diagram showing a process of logging in to an advertisement supply platform according to an embodiment of the present invention; and

FIG. 4 is a system block diagram showing an advertisement customization system and method according to an embodiment of the present invention.

### DETAILED DESCRIPTION OF PREFERRED EMBODIMENTS

The following illustrative embodiments are provided to illustrate the disclosure of the present invention. These and other advantages and effects will be apparent to those skilled in the art after reading the disclosure of this specification.

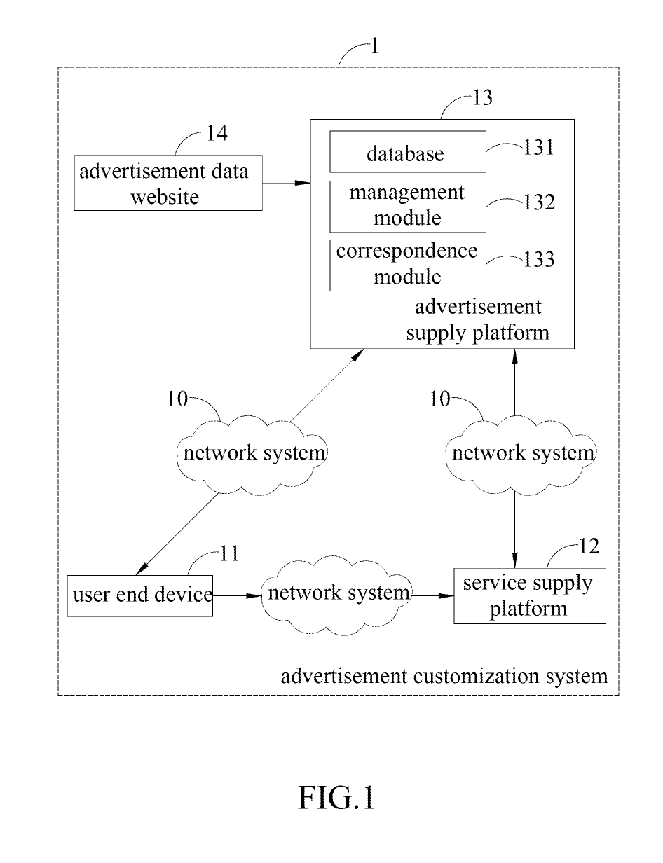

FIG. 1 is a system block diagram showing an advertisement customization system according to the present invention. For simplification, the diagram only shows components related to the present invention.

As shown in the diagram, the advertisement customization system 1 is applied to a network system 10. The advertisement customization system 1 comprises a user end device 11, a service supply platform 12, an advertisement supply platform 13 and an advertisement data website 14. The advertisement customization system 1 is detailed as follows.

The network system 10 is used as a medium for data transmission, which may be a wired network system such as an Ethernet, or a wireless network system such as a wireless local area network (WLAN), a global system for mobile communication (GSM), a general packet radio service (GPRS) system or a WiMax network system.

The user end device 11 can be any electronic device capable of connecting to the network system, for example, a personal computer, a notebook computer, a personal digital assistant (PDA) or a mobile phone.

The service supply platform 12 is connected to the user end device 11 through the network system 10 for providing service data to the user end device 11 and generating platform information corresponding to the service data. The service supply platform 12 can be a personal website, a web page, or a blog or vlog provided by a portal website. The service data comprises text, images, photos or videos displayed on a website, a web page and so on.

The advertisement supply platform 13 is connected to the service supply platform 12 through the network system 10 for providing advertisement data to the user end device 11 when the user end device 11 receives the service data of the service supply platform 12. The content of the advertisement data comprises text, photos, animations or videos.

The advertisement data website 14 is used for providing advertisement data of various advertisers to the advertisement supply platform 13.

The above-described advertisement supply platform 13 further comprises a database 131, a management module 132 and a correspondence module 133.

The database 131 stores the advertisement data provided by the advertisement data website 14.

The management module 132 manages and classifies the advertisement data of the database 131 according to the properties thereof. The properties of the advertisement data comprise advertising content, description and/or format. The advertising content comprises text, images, animations and/or videos. The advertising description is a tag under an advertisement, which denotes, for example, whether the advertisement is funny or serious. The advertising format denotes whether an advertisement is suitable for personal websites, web pages or portal websites.

According to the property of the service supply platform 12, the type of the service data, or settings provided by the service supply platform 12, the correspondence module 133 provides the corresponding advertisement data to the user end device 11. The properties of the service supply platform 12 refer to a personal web page (website) or a portal website. The type of service data can indicate the presence of text, images, animation and/or videos, or indicate whether, for example, the service data is funny, serious or the service data is related to sports or pets.

In practice, the management module 132 classifies the advertisement data according to the properties thereof. Further, according to the platform information of the service supply platform 12, the correspondence module 133 lists all the corresponding advertisement data for the service supply platform 12 to select. Then, when the user end device 11 receives the service data of the service supply platform 12, the advertisement supply platform 13 transmits the selected advertisement data to the user end device 11. Therefore, the service supply platform 12 can select suitable advertisement data according to the properties or content of the service data, thereby increasing users' interest in browsing advertisements.

In a preferred embodiment, the management module 132 classifies the advertisement data according to the properties thereof. According to the type of the service data and by using a random method, tag comparison, string comparison, or a content analysis method, the correspondence module 133 provides the corresponding advertisement data to the service supply platform 12 for selection or setting. Thereby, advertisement data that is not related to the service content is prevented from being provided to the service supply platform 12.

In another embodiment, the management module 132 classifies the advertisement data according to the properties thereof and lists the classified advertisement data for the service supply platform 12 to set. The service supply platform 12 selects at least a piece of advertisement data from the classified advertisement data so as to form settings. Subsequently, when the user end device 11 receives the service data, the correspondence module 133 provides the corresponding advertisement data to the user end device 11 according to the settings. Therefore, the service supply platform 12 can select advertisement data that is more related to the service data from the classified advertisement data.

In a preferred embodiment, the above-described service supply platform 12 can change or modify the content of the advertisement data.

In another preferred embodiment, the above-described user end device 11 or service supply platform 12 can transmit self-edited advertisement data to the advertisement supply platform 13 through the network system 10.

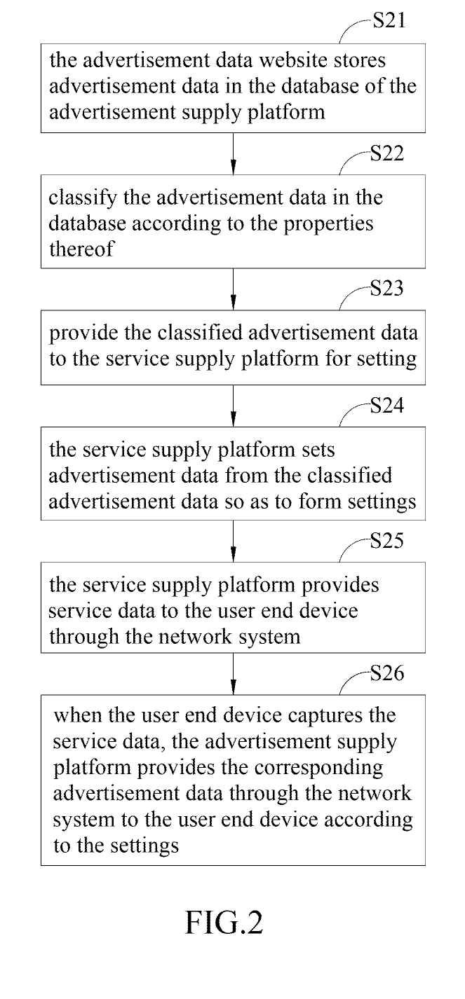

FIG. 2 is a flow diagram showing an advertisement customization method according to the present invention. The advertisement customization method is applied to the advertisement customization system 1. As shown in the drawing, the advertisement customization method comprises the following steps.

In step S21, the advertisement data website stores advertisement data in the database of the advertisement supply platform. Then, the process goes to step S22.

In step S22, the management module of the advertisement supply platform manages and classifies the advertisement data in the database according to the properties thereof. Therein, the properties of the advertisement data comprises advertising content, description and/or format, and the advertising content comprises text, images, animations and/or videos. Then, the process goes to step S23.

In step S23, the advertisement supply platform provides the classified advertisement data to the service supply platform for setting. Then, the process goes to step S24.

In step S24, the service supply platform sets advertisement data from the classified advertisement data so as to form settings. Then, the process goes to step S25.

In step S25, the service supply platform provides service data to the user end device through the network system. Then, the process goes to step S26.

In step S26, when the user end device receives the service data, the advertisement supply platform provides the corresponding advertisement data through the network system to the user end device according to the settings.

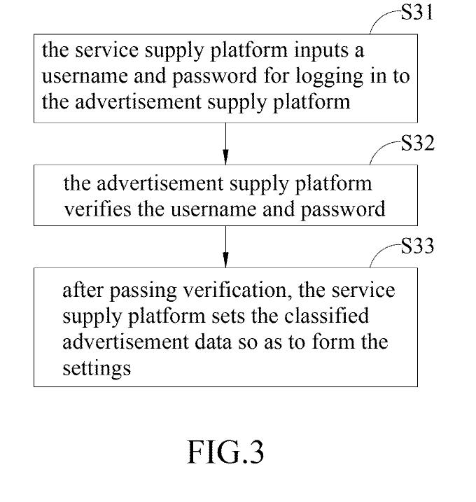

FIG. 3 shows a method of logging in to an advertisement supply platform according to an embodiment of the present invention. As shown in the drawing, before step S24 of FIG. 2, step S31 is performed, wherein the service supply platform inputs a username and password for logging in to the advertisement supply platform. Then, the process goes to step S32.

In step S32, the advertisement supply platform verifies the username and password. Then, the process goes to step S33.

In step S33, after passing the verification, the service supply platform sets the classified advertisement data so as to form the settings.

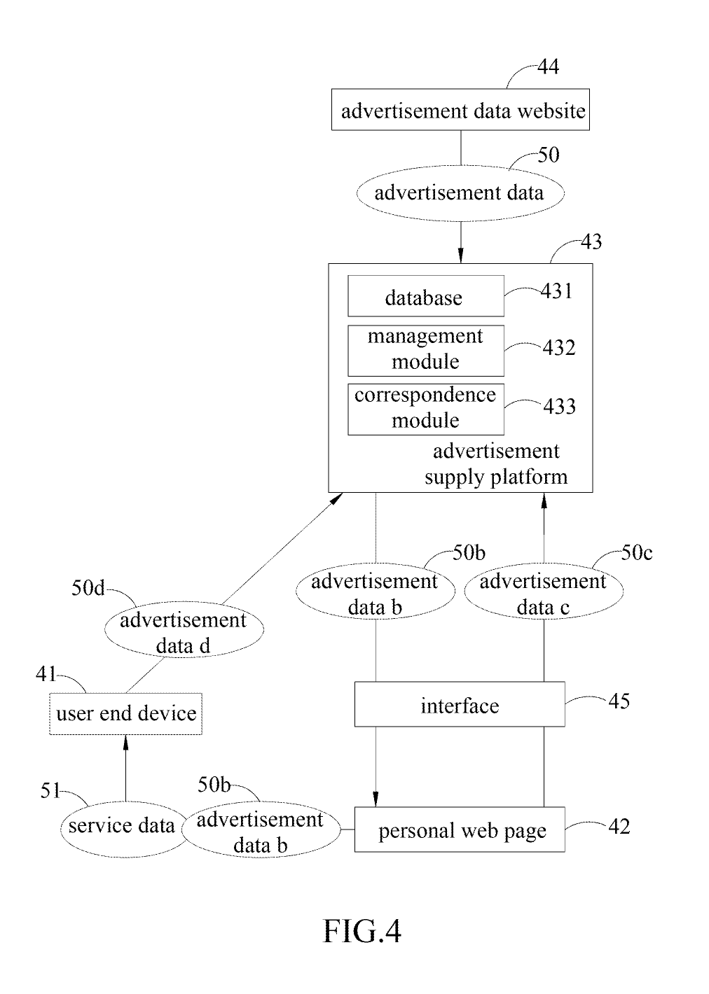

FIG. 4 shows an advertisement customization system and method according to another embodiment of the present invention.

As shown in the drawing, first, an advertisement data website 44 provides advertisement data 50 of all advertisers to an advertisement supply platform 43, and a management module 432 of the advertisement supply platform 43 classifies the advertisement data 50 according to the properties thereof and stores the classified advertisement data 50 to a database 431. Subsequently, through a network system, a personal web page 42 inputs a username and password on an interface 45 so as to log in to the advertisement supply platform 43. The advertisement supply platform 43 selects advertisement data that matches the properties of the personal web page 42 (if a blog is applied, advertisement data that matches the property of the blog is selected). There are two methods for the advertisement supply platform 43 to provide advertisement data: first, a correspondence module 433 provides corresponding advertisement data 50b according to service data 51 provided by the personal web page 42 and by using a random method, tag comparison, string comparison or a content analysis method; second, the classified advertisement data is displayed through the interface 45 for the personal web page 42 to set, wherein the personal web page 42 can set the advertisement data according to the content or description thereof, and the correspondence module 433 provides corresponding advertisement data 50b according to the settings of the personal web page 42.

The first method provides advertisement data 50b that is related to the service data 51, while the second method not only provides advertisement data 50b that is related to the service data 51, but also enables the personal web page 42 to customize the advertisement data, thereby overcoming the conventional drawbacks in which irrelevant advertisements are provided and advertisements cannot be customized, increasing advertisers' willingness to advertise.

Further, when the user end device 41 captures the service data 51 through the network system, the advertisement supply platform 43 provides the advertisement data 50b to the user end device 41. For example, when the personal web page 42 displays a personal travel photo of a person pulling a suitcase, the personal web page 42 sets the suitcase, connects to the advertisement supply platform 43 through the interface 45, and sets advertisement data 50b from the classified advertisement data with its advertising content being ‘photo’ and advertising description being ‘outdoor’ or ‘suitcase’. Thereafter, when the user end device 41 browses the personal web page 43 and clicks the suitcase, the advertisement supply platform 32 provides the advertisement data 50b to the user end device 41.

In another example, when the personal web page 42 publishes a short video of playing basketball, the personal web page 42 connects to the advertisement supply platform 43 through the interface 45 and sets advertisement data 50b from the classified advertisement data with its advertising content being ‘video’ and advertising description being ‘sport’ or ‘basketball shoes’. Then, after the user end device 41 watches the video, the advertisement data 50b is transmitted by the advertisement supply platform 43 to the user end device 41 for viewing.

Therefore, when the user end device 41 browses the service data 51 of the personal web page 42, the user end device 41 indirectly browses the advertisement data 50b provided by the advertisement supply platform 43, thereby overcoming the conventional drawbacks in which the advertisement data 50b and the service data 51 are located at different regions so as to cause the user end device 41 to skip the advertisement, thus increasing the view rate or clicking rate of the advertisement.

In addition, the personal web page 42 can change or modify the advertisement data 50b and the user end device 41 or personal web page 42 can self-edit the advertisement data 50d or advertisement data 50c and transmit it to the advertisement supply platform 43.

Therefore, the present invention achieves the following effects:
(1) Customizing advertisements to be related to personal platforms increases the view rate. An advertisement supply platform manages and classifies advertisement data comprising text, images, animations and/or videos that are provided by an advertisement data website, and a service supply platform sets advertisement data from the classified advertisement data. Since the advertisement data set by the service supply platform is related to the service data, the view rate of the advertisement is increased.
(2) Advertisers' willingness to advertise is increased. Since the advertisement data set by the service supply platform is related to the service data, the view rate of the advertisement is increased and advertisers' willingness to advertise is also increased, which accordingly increases the income of owners of the service supply platform and advertisement supply platform.

The above-described descriptions of the detailed embodiments are provided to illustrate the preferred implementation according to the present invention, and are not intended to limit the scope of the present invention. Accordingly, various modifications and variations completed by those with ordinary skill in the art will fall within the scope of the present invention as defined by the appended claims.

What is claimed is:

1. An advertisement customization system applied in a network system, comprising:
a user end device;
a service supply platform connected to the user end device through the network system for supplying service data to the user end device and generating platform information corresponding to the service data; and
an advertisement supply platform connected to the service supply platform through the network system for providing advertisement data to the user end device when the user end device receives the service data of the service supply platform, wherein the advertisement supply platform comprises:
a database for storing the advertisement data;
a management module for classifying the advertisement data in the database; and
a correspondence module which transmits the advertisement data that corresponds to the platform information to the user end device when the user end device receives the service data of the service supply platform.

2. The system of claim 1, further comprising an advertisement data website for providing various kinds of advertisement data to the advertisement supply platform through the network system.

3. The system of claim 1, wherein the advertisement supply platform further comprises an advertisement change interface that allows the service supply platform to log in so as to set, change or modify the advertisement data.

4. The system of claim 1, wherein the platform information comprises the properties of the service supply platform, customized settings of the service supply platform and the type of the service data.

5. The system of claim 4, wherein, according to the properties of the supply service platform, the advertisement supply platform provides corresponding advertisement data to the service supply platform for setting, and further the set advertisement data is provided to the user end device when the user end device receives the service data.

6. The system of claim 4, wherein, according to the type of the service data and by using a random, tag comparison, string comparison, or content analysis method, the advertisement supply platform provides corresponding advertisement data to the user end device when the user end device receives the service data.

7. The system of claim 1, wherein the advertisement supply platform classifies the advertisement data according to the properties thereof, and provides the classified advertisement data to the service supply platform for setting.

8. The system of claim 7, wherein the service supply platform sets advertisement data from the classified advertisement data so as to form settings.

9. The system of claim 7, wherein the properties of the advertisement data comprises advertising type, content, description, format and/or expression style.

10. The system of claim 9, wherein the advertising content comprises text, graphic images, photos, animation and/or videos.

11. An advertisement customization method applied in an advertisement customization system, the method comprising the steps of:
(1) an advertisement supply platform classifying advertisement data stored in a database;
(2) a service supply platform logging in to the advertisement supply platform for setting the classified advertisement data so as to form settings;
(3) the service supply platform providing service data to a user end device through a network system; and
(4) when the user end device receives the service data, the advertisement supply platform providing corresponding advertisement data through the network system to the user end device according to the settings.

12. The method of claim 11, wherein, in step (1), the advertisement data is provided by an advertisement data website to the advertisement supply platform through the network system.

13. The method of claim 11, wherein step (2) further comprises the steps of:
(2-1) the service supply platform inputting a username and password so as to log in to the advertisement supply platform;
(2-2) the advertisement supply platform verifying the username and password; and
(2-3) after passing the verification, the service supply platform setting the classified advertisement data so as to form the settings.

14. The method of claim 11, wherein, according to the type of the service data and by using a random, tag comparison, string comparison, or content analysis method, the advertisement supply platform provides the corresponding advertisement data to the user end device when the user end device receives the service data.

15. The method of claim 11, wherein the service supply platform changes or modifies the content of the advertisement data.

16. The method of claim 11, wherein the user end device or service supply platform transmits self-edited advertisement data to the advertisement customization system.
